(19) United States
(12) Patent Application Publication
(10) Pub. No.: US 2024/0169450 A1
(43) Pub. Date: May 23, 2024

(54) REPLY METHOD AND DEVICE, COMPUTER DEVICE AND STORAGE MEDIUM

(71) Applicant: Beijing Zitiao Network Technology Co., Ltd., Beijing (CN)

(72) Inventors: Huijing NIE, Beijing (CN); Yifan TAN, Beijing (CN)

(21) Appl. No.: 18/512,351

(22) Filed: Nov. 17, 2023

(30) Foreign Application Priority Data
Nov. 18, 2022 (CN) 202211447290.5

(51) Int. Cl. G06Q 50/00; G06F 16/28

(52) U.S. Cl. CPC G06Q 50/01; G06F 16/287

(57) ABSTRACT

The present disclosure provides a reply method and device, a computer device and a storage medium. The method comprises: determining a topic to be replied among posted book recommendation topics; wherein the topic to be replied corresponds to at least one book recommendation feature; determining a target recommended book matched with the topic to be replied, and determining book recommendation information of the target recommended book; wherein the book recommendation information contains information matched with at least some of book recommendation features; and generating topic reply information of the topic to be replied based on the target recommended book and the book recommendation information.

### CROSS-REFERENCE TO RELATED APPLICATIONS

The present application is based on and claims priority to Chinese Patent Application No. 202211447290.5 filed on Nov. 18, 2022, and entitled “REPLY METHOD AND DEVICE, COMPUTER DEVICE AND STORAGE MEDIUM”, the disclosure of which is incorporated by reference herein in its entirety.

### TECHNICAL FIELD

The present disclosure relates to the field of computer technology, in particular to a reply method and device, a computer device and a storage medium.

### BACKGROUND

In the existing online reading applications, a user communication function is usually provided so that the user can interact with other users by posting a book recommendation topic with the function. However, in the existing related technologies, in the case where there are many book recommendation topics posted by the user, it often happens that the book recommendation topics cannot be replied in time, which results in that the user who posts a book recommendation topic cannot obtain the relevant information about a book of interest, thereby affecting the use experience of an online reading application by the user.

### SUMMARY

The embodiment of the present disclosure at least provides a reply method and device, a computer device and a storage medium.

In a first aspect, a reply method applied to a server is provided in an embodiment of the present disclosure. The method comprises: determining a topic to be replied among posted book recommendation topics; wherein the topic to be replied corresponds to at least one book recommendation feature; determining a target recommended book matched with the topic to be replied, and determining book recommendation information of the target recommended book; wherein the book recommendation information contains information matched with at least some of book recommendation features; and generating topic reply information of the topic to be replied based on the target recommended book and the book recommendation information.

In an optional implementation, the determining the target recommended book matched with the topic to be replied comprises: determining a plurality of book screening features based on topic content of the topic to be replied; determining a book recommendation collection corresponding to each of the book screening features among a plurality of candidate recommended books so as to obtain a plurality of book recommendation collections; and determining a book satisfying a book recommendation requirement among the plurality of book recommendation collections as the target recommended book.

In an optional implementation, the book screening features comprise at least one of the following: gender information of a posting user of the topic to be replied, a book recommendation label of the topic to be replied, or operation information of a related book on which a target operation is performed by the posting user, wherein the book recommendation label is configured to indicate classification information of a book associated with the topic to be replied, and the target operation comprises at least one of the following: a reading operation or a commenting operation.

In an optional implementation, the determining the book recommendation information of the target recommended book comprises: determining a first recommendation topic matched with the target recommended book among posted book recommendation topics; determining target topic content associated with the target recommended book in topic content of the first recommendation topic; wherein the target topic content comprises at least one of the following: topic reply content or topic recommendation content; and extracting a recommendation keyword associated with the book recommendation features of the topic to be replied from the target topic content, and generating the book recommendation information based on the recommendation keyword.

In an optional implementation, the determining the target recommended book matched with the topic to be replied comprises: extracting book delivery information from the topic content of the topic to be replied; wherein the book delivery information is configured to indicate a target delivery platform of multimedia information of a book associated with the topic to be replied; and determining the target recommended book among books delivered by the target delivery platform based on the book delivery information.

In an optional implementation, the determining the book recommendation information of the target recommended book comprises: obtaining target delivery information of the target recommended book on the target delivery platform, wherein the target delivery information comprises multimedia delivery information of the target recommended book and/or comment information of the multimedia delivery information; and extracting critical delivery information matched with the book recommendation features of the topic to be replied from the target delivery information, and determining the book recommendation information of the target recommended book based on the critical delivery information.

In an optional implementation, the method further comprises: obtaining at least one preset reply template, and determining a target reply template matched with the topic to be replied in the at least one preset reply template; and the generating the topic reply information of the topic to be replied based on the target recommended book and the book recommendation information comprises: generating the topic reply information of the topic to be replied based on the target reply template, the target recommended book and the book recommendation information.

In an optional implementation, the target reply template contains a plurality of filling positions; the generating the topic reply information of the topic to be replied based on the target reply template, the target recommended book and the book recommendation information comprises: determining filling content of each of the filling positions based on the topic to be replied, and generating a first reply information based on the filling content; generating a second reply information based on the target recommended book and the book recommendation information; and combining the first reply information and the second reply information to obtain the topic reply information.

In a second aspect, a reply method applied to a client is provided in an embodiment of the present disclosure. The method comprises: detecting a topic browsing request and determining a target recommendation topic corresponding to the topic browsing request; obtaining topic content of the target recommendation topic; wherein the topic content comprises topic recommendation content and topic reply content, and the topic reply content is the topic reply information generated for the target recommendation topic by the reply method according to any of the above-described first aspect; and displaying the topic reply content in a topic reply area of a topic display page.

In an optional implementation, the displaying the topic reply content in the topic display page comprises: determining a target recommended book in the topic reply content, and determining a book display identifier of the target recommended book; determining text content in the topic reply content, and extracting critical text information of the text content; and displaying the book display identifier in a multimedia display area of the topic reply area, and displaying the critical text information in a text display area of the topic reply area.

In an optional implementation, the method further comprises: switching to a recommendation details page displaying the target recommended book in response to a triggering operation on the book display identifier; wherein the recommendation details page comprises: a book reading page of the target recommended book and/or, a delivery page of multimedia delivery information of the target recommended book on a target delivery platform.

In a third aspect, a reply device is provided in an embodiment of the present disclosure. The device comprises: a first determining unit configured to determine a topic to be replied among posted book recommendation topics; wherein the topic to be replied corresponds to at least one book recommendation feature; a second determining unit configured to determine a target recommended book matched with the topic to be replied, and determine book recommendation information of the target recommended book; wherein the book recommendation information contains information matched with at least some of book recommendation features; and a generating unit configured to generate topic reply information of the topic to be replied based on the target recommended book and the book recommendation information.

In a fourth aspect, a reply device is provided in an embodiment of the present disclosure. The device comprises: a detecting unit for detecting a topic browsing request; a third determining unit configured to determine a target recommendation topic corresponding to the topic browsing request; an obtaining unit configured to obtain topic content of the target recommendation topic; wherein the topic content comprises topic recommendation content and topic reply content, and the topic reply content is the topic reply information generated for the target recommendation topic by the reply method according to any of the above-described first aspect; and a displaying unit configured to display the topic reply content in a topic reply area of a topic display page.

In a fifth aspect, a computer device is provided in an embodiment of the present disclosure. The computer device comprises a processor, a memory and a bus, wherein the memory stores machine-readable instructions executable by the processor, so that the processor communicates with the memory via the bus during the operation of the computer device; and the machine-readable instructions, when executed by the processor, perform the steps in the above-described first aspect or any possible implementation of the first embodiment.

In a sixth aspect, a non-transitory computer-readable storage medium is provided in an embodiment of the present disclosure. The non-transitory computer-readable storage medium has a computer program stored thereon that, when executed by a processor, performs the steps in the above-described first aspect or any possible implementation of the first embodiment.

In an embodiment of the present disclosure, first of all, a topic to be replied is determined among posted book recommendation topics, wherein the topic to be replied corresponds to at least one book recommendation feature. Then, a target recommended book matched with the topic to be replied may be determined, and book recommendation information of the target recommended book is determined, wherein the book recommendation information contains information matched with at least some book recommendation features. Then, topic reply information of the topic to be replied may be generated based on the target recommended book and the book recommendation information.

In the above-described embodiment, by generating the topic reply information based on the target recommended book and the book recommendation information, the topic reply information can be automatically generated for the topic to be replied, thereby automatically replying to the topic to be replied, and enabling a faster access to a recommended book by the user. By determining the target recommended book matched with the book recommendation features of the topic to be replied and the book recommendation information, it is possible to obtain the target recommended book that conforms more to a book recommendation intent of the user, so as to obtain the topic reply information more matched with the topic to be replied, and further improving the reading experience of the user.

In order to make the above-described objects, features and advantages of the present disclosure more apparent and understandable, a detailed description will be made below with reference to preferred embodiments in conjunction with the accompanying drawings.

### BRIEF DESCRIPTION OF THE ACCOMPANYING DRAWINGS

In order to explain the technical solution according to the embodiments of the present disclosure more clearly, the accompanying drawings required to be used in the embodiments will be briefly introduced below, and the accompanying drawings here are incorporated into and constitute a part of this specification. These accompanying drawings show the embodiments conforming to the present disclosure and serve to explain the technical solution of the present disclosure together with the specification. It should be understood that, the following accompanying drawings only show some embodiments of the present disclosure, and thus should not be regarded as limitation to the scope. For those of ordinary skill in the art, other related accompanying drawings may also be obtained according to these accompanying drawings without any inventive effort.

FIG. 1 shows a flowchart of a reply method provided by an embodiment of the present disclosure;

FIG. 2 shows a flowchart of a specific method for determining a target recommended book matched with a topic to be replied in the reply method provided by an embodiment of the present disclosure;

FIG. 3 shows a flowchart of another specific method for determining a target recommended book matched with a topic to be replied in the reply method provided by an embodiment of the present disclosure;

FIG. 4 shows a flowchart of another reply method provided by an embodiment of the present disclosure;

FIG. 5 shows a schematic effect view of a topic browsing page provided by an embodiment of the present disclosure;

FIG. 6 shows a schematic view of a first reply device provided by an embodiment of the present disclosure;

FIG. 7 shows a schematic view of a second reply device provided by an embodiment of the present disclosure;

FIG. 8 shows a schematic view of a computer device provided by an embodiment of the present disclosure.

### DETAILED DESCRIPTION

In order to make the objects, technical solutions and advantages of the embodiments of the present disclosure more explicit, the technical solution in the embodiments of the present disclosure will be explicitly and completely described in conjunction with the accompanying drawings in the embodiments of the present disclosure. Apparently, the embodiments described are only some embodiments of the present disclosure, rather than all of the embodiments. Generally, the components of the embodiments of the present disclosure depicted and illustrated in the accompanying drawings here may be arranged and designed in various different configurations. Therefore, the following detailed description of the embodiments of the present disclosure provided in the accompanying drawings is not intended to limit the scope of the claimed disclosure, but only represents selected embodiments of the present disclosure. Based on the embodiments of the present disclosure, all the other embodiments obtained by those skilled in the art without any inventive effort fall within the protection scope of the present disclosure.

It should be noted that: similar symbols and letters indicate similar items in the following accompanying drawings, so that once an item is defined in one accompanying drawing, there is no need to further define and explain the same in subsequent accompanying drawings.

The term “and/or” herein only describes an association relationship, which means that there may be three types of relationship, for example, A and/or B may mean A alone, both A and B, or B alone. In addition, the term “at least one” herein means any one or any combination of at least two of a plurality, for example, including at least one of A, B or C may mean including any one or more elements selected from a set of A, B and C.

It has been found through studies that, in the existing online reading applications, a user communication function is usually provided so that the user can interact with other users by posting a book recommendation topic with the function. For example, an application of “XX Fiction” may comprise a function module of “Topic Square” in which the user may post a book-related topic, such as a book recommendation topic. Other users may reply to the book-related topic, for example, posting related book recommendation information in the book recommendation topic, so as to realize the interaction between users.

However, in the existing related technologies, in the case where there are many book recommendation topics posted by the user, it often happens that the book recommendation topics cannot be replied in time, which results in that the user who posts a book recommendation topic cannot obtain the relevant information about a book of interest, thereby affecting the use experience of an online reading application by the user.

Based on the above-described research, the present disclosure provides a reply method and device, a computer device and a storage medium. In an embodiment of the present disclosure, first of all, a topic to be replied is determined among posted book recommendation topics, wherein the topic to be replied corresponds to at least one book recommendation feature. Then, it is possible to determine a target recommended book matched with the topic to be replied, and determine book recommendation information of the target recommended book, wherein the book recommendation information contains information matched with at least some book recommendation features. Then, topic reply information of the topic to be replied may be generated based on the target recommended book and the book recommendation information.

In the above-described embodiment, by generating the topic reply information based on the target recommended book and the book recommendation information, the topic reply information may be automatically generated for the topic to be replied, thereby automatically replying to the topic to be replied, and enabling a faster access to a recommended book by the user in time. By determining the target recommended book matched with the book recommendation features of the topic to be replied and the book recommendation information, it is possible to obtain the target recommended book that conforms more to a book recommendation intent of the user, so as to obtain the topic reply information more matched with the topic to be replied, and further improving the reading experience of the user.

In order to facilitate the understanding of this embodiment, first of all, a reply method disclosed in an embodiment of the present disclosure is introduced in detail. The reply method provided in the embodiment of the present disclosure is generally performed by a computer device having certain computing power, which comprises, for example, a terminal device, a server or other processing devices. The terminal device may be a User Equipment (UE), a mobile device, a user terminal, a terminal and the like. In some possible implementations, the reply method may be realized by a processor by calling computer-readable instructions stored in a memory.

### First Embodiment

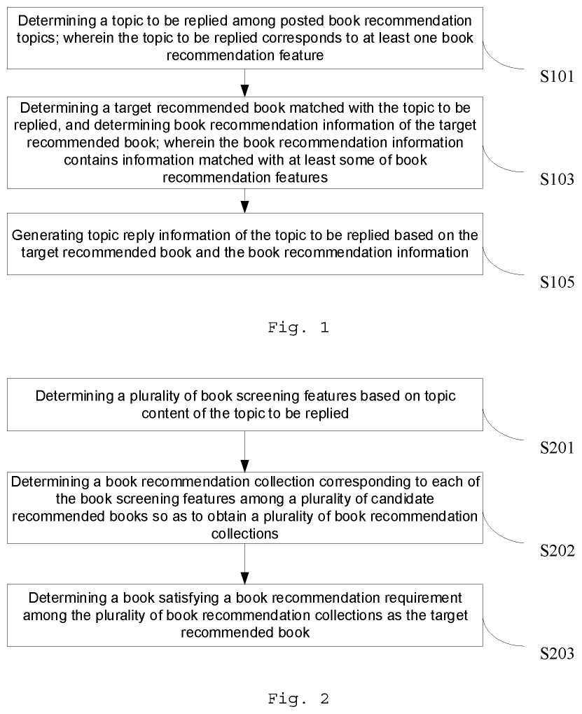

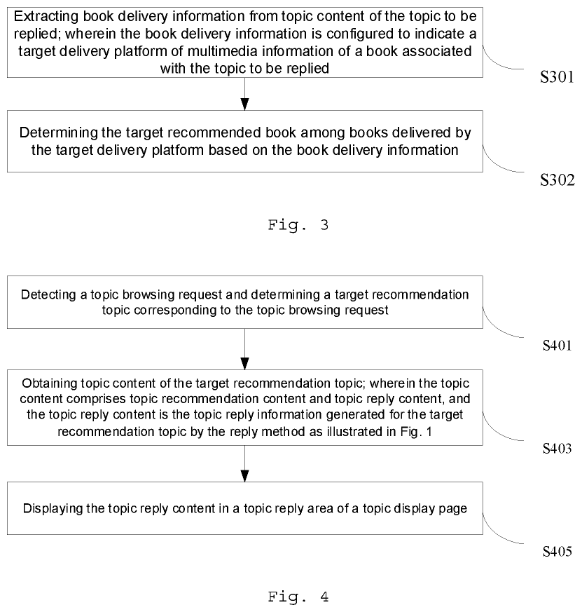

Referring to FIG. 1, which is a flowchart of a reply method provided by an embodiment of the present disclosure. The reply method is applied to a server, and the method comprises steps S101˜S105, wherein:
S101: a topic to be replied is determined among posted book recommendation topics; wherein the topic to be replied corresponds to at least one book recommendation feature.

In an embodiment of the present disclosure, the topic to be replied may be determined among the posted book recommendation topics according to a preset screening duration, wherein the preset screening duration may be one day, one week, or other time durations, and the present disclosure is not specifically limited thereto.

Here, the book recommendation feature may comprise a book screening feature and a book delivery platform; wherein the book delivery platform is configured to indicate a delivery platform of related materials of a book. The related materials may comprise at least one of the following: a book introduction video, a sample of an excellent plot of a book, a preview of a book screen or other types of materials. The delivery platform comprises at least one of the following: a short video platform, a shopping software platform or a video player platform.

In an embodiment of the present disclosure, the book screening features comprise at least one of the following: gender information of a posting user of the topic to be replied, a book recommendation label of the topic to be replied, or operation information of a related book on which a target operation is performed by the posting user, wherein the book recommendation label is configured to indicate classification information of a book associated with the topic to be replied, and the target operation comprises at least one of the following: a reading operation or a commenting operation.

Here, since the book recommendation label is configured to indicate the classification information of the book associated with the topic to be replied, the book recommendation label may also be configured to determine a book searching method corresponding to the topic to be replied. For example, the book recommendation label may be at least one of the following: a theme, a character, a plot or a form of article. At this time, the book searching method may be understood as: searching for a book according to the theme (for example, searching for a super excellent alternate history text), searching for a book according to the character (for example, “a book in which a heroine is super handsome”), searching for a book according to the plot (for example, a happy-ending article in which a heroine saves a hero), and searching for a book according to the form of article (for example, a short story). Wherein, the form of article is configured to indicate an update state of a book (for example, concluded, updating) and a length of a book (for example, a novel or a short story).

Here, the above-described book recommendation label may be determined by the following methods:

### First Method

Each topic to be replied may contain a corresponding topic label, at this time, the book recommendation label may be determined based on the topic label. For example, if the topic label contained in the topic to be replied is “Lin Qiye”, the book recommendation label is “Lin Qiye”, that is, searching for a book associated with “Lin Qiye”.

### Second Method

Critical topic information is extracted from topic content of the topic to be replied. Then, the book recommendation label is determined based on the critical topic information. For example, the critical topic information is: “Is there any book with a super handsome heroine”, at this time, the book recommendation label may be determined to be the character, i.e., searching for a book according to the character, based on the critical topic information.

Here, the book screening feature may further comprise operation information of a related book on which a target operation is performed by a posting user, for example, operation information of a related book on which a reading operation is performed by the posting user or operation information of a related book on which a commenting operation is performed by the posting user.

In the case where the target operation is the reading operation, the operation information may comprise at least one of the following: a continuous reading duration, a cumulative reading duration, a total duration of loading a book, a total count of loaded word of a book, total times of reading a book, a reading frequency of a book or other information associated with the reading operation.

In the case where the target operation is the commenting operation, the operation information may comprise at least one of the following: number of comments, frequencies of comments, types of comments (for example, a book review, a chapter review or a paragraph review), favorability of comments or other information associated with the commenting operation.

In S103, a target recommended book matched with the topic to be replied is determined, and book recommendation information of the target recommended book is determined; wherein the book recommendation information contains information matched with at least some of book recommendation features.

Here, there may be a plurality of target recommended books, and the corresponding book recommendation information may be determined for each target recommended book. Alternatively, the same book recommendation information may be determined for a plurality of target recommended books. The book recommendation information is configured to indicate recommendation information of the target recommended book corresponding to the book recommendation features.

For example, the book recommendation feature is a book recommendation label: the character-heroine is super handsome, and the target recommended book is XXX. At this time, the book recommendation information may be the information concerning that the heroine is particularly handsome in the target recommended book.

Here, the book recommendation information of the target recommended book may be determined based on at least one of comment information (a book review, a chapter review or a paragraph review) of the target recommended book, a related topic of the book or related materials of the book.

In S105, topic reply information of the topic to be replied is generated based on the target recommended book and the book recommendation information.

In an embodiment of the present disclosure, the topic reply information of the topic to be replied may be generated according to a preset reply template, and the topic to be replied may be replied by at least one target account.

Here, the target account may be at least one official account of an online reading application, wherein the preset reply templates corresponding to different official accounts may be different.

In an embodiment of the present disclosure, by generating the topic reply information based on the target recommended book and the book recommendation information, the topic reply information may be automatically generated for the topic to be replied, thereby automatically replying to the topic to be replied, and enabling a faster access to a recommended book by the user. By determining the target recommended book matched with the book recommendation features of the topic to be replied and the book recommendation information, it is possible to obtain the target recommended book that conforms more to a book recommendation intent of the user, so as to obtain the topic reply information more matched with the topic to be replied, and further improving the reading experience of the user.

The above-described steps will be introduced in conjunction with specific embodiments.

In an embodiment of the present disclosure, first of all, a topic to be replied may be determined among posted book recommendation topics, wherein the topic to be replied may be a topic that satisfies a topic reply requirement among the posted book recommendation topics.

Here, the topic to be replied may be screened by the following dimensions: whether a reply from other users has been received, whether it is marked as requiring an official reply, and whether a reply from other users has been received with no substantive content.

In a specific implementation, the topic for which a reply has not been received from other users may serve as a topic to be replied among the posted book recommendation topics. The topic which is marked by the user as requiring an official reply may serve as a topic to be replied. The topic for which there is a small amount of reply information and a book matched with the book recommendation topic cannot be obtained from the replied content may serve as a topic to be replied. The topic for which the topic posting time is within a preset time period (for example, within one week) and a reply has not been received from other users may serve as a topic to be replied.

After the topic to be replied is determined according to the method described above, at least one book recommendation feature corresponding to the topic to be replied may be determined. In a specific implementation, it is possible to determine a delivery platform of related materials of a book and a book screening feature of the topic to be replied, so as to obtain at least one book recommendation feature of the topic to be replied.

Next, a target recommended book matched with the topic to be replied may be determined. The following will introduce how to determine the target recommended book in conjunction with the following methods.

### First Determining Method

In the first determining method, as shown in FIG. 2, the above-described step S103 of determining the target recommended book matched with the topic to be replied specifically comprises the following steps:
in step S201, a plurality of book screening features are determined based on topic content of the topic to be replied;
in step S202, a book recommendation collection corresponding to each of the book screening features is determined among a plurality of candidate recommended books so as to obtain a plurality of book recommendation collections; and
in step S203, a book that satisfies a book recommendation requirement is determined among the plurality of book recommendation collections as the target recommended book.

In an embodiment of the present disclosure, the topic content of the topic to be replied may comprise at least one of the following: a topic title of the topic to be replied, a topic original of the topic to be replied, a topic label of the topic to be replied, interactive information of the topic to be replied, or other contents associated with the topic to be replied.

In a specific implementation, content matched with each feature dimension may be extracted from the above-described topic content, so as to determine a book screen feature under a corresponding feature dimension based on the matched content, wherein the feature dimension comprises at least one of the following:
Gender dimension, wherein the gender dimension corresponds to “gender information of a posting user of the topic to be replied” in the book screening features;
A label dimension, wherein the label dimension corresponds to “a book recommendation label of the topic to be replied” in the book screening features;
An interactive dimension, wherein the interactive dimension corresponds to “operation information of a related book on which a target operation is performed by a posting user” in the book screening features.

For example, for the gender dimension, a gender label may be extracted from the topic label of the topic to be replied, so as to determine the gender information of a posting user of the topic to be replied based on the gender label. For another example, for the label dimension, a book recommendation label of the topic to be replied may be determined by the methods described in the first and second methods above. For another example, for the interactive dimension, the operation information of a related book on which a target operation is performed by a posting user may be extracted from the interactive information of the topic to be replied.

After a plurality of book screening features are determined according to the method described above, a preliminarily screened book matched with each book screening feature may be determined among a plurality of candidate recommended books, so as to obtain a book recommendation collection, wherein, for each book screening feature, a corresponding book recommendation collection may be determined so as to obtain a plurality of book recommendation collections.

In a specific implementation, each book screening feature may be matched with a book attribute feature of each candidate recommended book, so that a collection of candidate recommended books matched with the book screening feature may be determined as a book recommendation collection corresponding to the book screening feature.

After a plurality of book recommendation collections are determined, it is possible to determine an intersection of the plurality of book recommendation collections, so that a candidate recommended book in the intersection may be determined as a book that satisfies the book recommendation requirement, that is, a candidate recommended book in the intersection may be understood as the above-described target recommended book.

Suppose that the plurality of book screening features comprise: a first feature of gender information “female”, a second feature of book recommendation label “character Lin Qiye” and a third feature of operation information “reading operation”.

For the first feature, books associated with “female” may be screened out from a plurality of candidate recommended books, so as to obtain a first book recommendation collection. Then, books associated with “character Lin Qiye” may be screened out from the plurality of candidate recommended books, so as to obtain a second book recommendation collection. Next, books with top X reading durations of posting users may be screened out from the plurality of candidate recommended books, so as to obtain a third book recommendation collection. Finally, the intersection of the first book recommendation collection, the second book recommendation collection and the third book recommendation collection may be determined, so that the intersection may be determined as the target recommended book that satisfies the book recommendation requirement.

In the above-described embodiment, by determining the target recommended book matched with the book recommendation features of the topic to be replied, it is possible to obtain the target recommended book that conforms more to a book recommendation intent of the user, thereby obtaining the topic reply information more matched with the topic to be replied, and further improving the reading experience of the user.

### Second Determining Method

In this second determining method, as shown in FIG. 3, the above-described step S103 of determining the target recommended book matched with the topic to be replied specifically comprises the following steps:
in step S301, book delivery information is extracted from the topic content of the topic to be replied. The book delivery information is configured to indicate a target delivery platform of multimedia information of a book associated with the topic to be replied; and
in Step S302, the target recommended book is determined among books delivered by the target delivery platform based on the book delivery information.

For some books, related materials of the books (for example, information such as a book introduction video, a sample of an excellent plot of a book, a preview of a book screen) might have been delivered through other channels, for example, a short video platform. At this time, a delivery correlation relationship may be established in advance to indicate related materials corresponding to a book and a delivery platform of the related materials through the delivery correlation relationship.

In an embodiment of the present disclosure, the book delivery information of the book that the posting user intends to obtain may be extracted from the topic content of the topic to be replied. Then, the target recommended book may be determined based on the book delivery information and the delivery correlation relationship.

In a specific implementation, keywords associated with the delivery information may be extracted from the topic content. For example, if the topic content is “an emotional book delivered by XXX short video platform”, the extracted keywords may be XXX short video and an emotional book. Then, the extracted keywords may be determined as the above-described book delivery information.

After the above-described book delivery information is determined, it is possible to determine a delivery platform indicated by the book delivery information, that is, a target delivery platform, for example, XXX short video platform. Then, a book matched with the “emotional book” in the book delivery information is searched in the books posted on XXX short video platform as a target recommended book.

In a specific implementation, it is possible to obtain all the books delivered on the target delivery platform, and obtain book attribute feature of each book. Then, the book attribute feature is matched with the book delivery information, so that a book matched with the book delivery information is determined among all the books as a target recommended book.

In the above-described embodiment, by determining a target recommended book for the posting user on the target delivery platform, it is possible to enrich the recommendation method of the target recommended book and meet various book recommendation requests of the user.

For the target recommended book determined by the above-described second determining method, the book recommendation information of the target recommended book may be determined by the following method, which specifically comprises the following steps:
in step S11, target delivery information of the target recommended book is obtained on the target delivery platform, wherein the target delivery information comprises: multimedia delivery information of the target recommended book, and/or comment information of the multimedia delivery information; and
in step S12, critical delivery information matched with the book recommendation features of the topic to be replied is extracted from the target delivery information, and the book recommendation information of the target recommended book is determined based on the critical delivery information.

In an embodiment of the present disclosure, after the target recommended book is determined, the target delivery information of the target recommended book on the target delivery platform may be determined. For example, the target delivery information may be: various types of the multimedia delivery information such as a book introduction video, a sample of an excellent plot of a book, a preview of a book screen. In addition, the target delivery information may also be comment information of the multimedia delivery information. For example, for a book introduction video, other network users may add a book review of the target recommended book on a reply page of the video, and at this time, the target delivery information may be determined from all the comment information of the book introduction video.

In a specific implementation, the target comment information that satisfies a comment requirement may be extracted from all the comment information of the multimedia delivery information. Wherein, the comment requirement may be determined based on the following parameters: parameters such as positive review rating for a comment, number of likes for a comment and number of replies for a comment. For example, the comment information with the highest positive review rating for a comment may be determined as the above-described target comment information. After the target comment information is determined, the target comment information may be determined as the comment information of the multimedia information in the target delivery information.

After the target delivery information is determined, it is possible to extract the critical delivery information matched with the book recommendation features of the topic to be replied from the target delivery information, so that the topic reply information of the topic to be replied, that is, the book recommendation information of the target recommended book, may be generated based on the critical delivery information.

In an optional embodiment, a book review keyword matched with the book recommendation features may be extracted from the above-described determined target comment information. Then, the critical delivery information may be determined based on the multimedia delivery information and the book review keyword.

In another optional embodiment, a book review keyword matched with the book recommendation features may be extracted from the above-described determined target comment information, and text information matched with the book recommendation features may be determined based on the multimedia delivery information. Then, the critical delivery information may be determined based on the text information and the book review keyword.

In a specific implementation, for the video or audio multimedia delivery information, audio information of the multimedia delivery information may be converted into an initial text. Then, the text information matched with the book recommendation features may be determined in the initial text. For the image multimedia delivery information, initial characters may be extracted from the image. Then, the text information matched with the book recommendation features is determined in the initial characters.

In the above-described embodiment, by extracting the critical delivery information from the target delivery information and determining the book recommendation information based on the critical delivery information, it is possible to determine the more matched book recommendation information for the user, thereby improving the use experience of the user.

For the target recommended book determined by the above-described first and second determining methods, the book recommendation information of the target recommended book may also be determined by the following method, which specifically comprises the following steps:
in step S21, a first recommendation topic matched with the target recommended book is determined among the posted book recommendation topics;
in step S22, target topic content associated with the target recommended book is determined in topic content of the first recommendation topic, wherein the target topic content comprises at least one of the following: topic reply content or topic recommendation content; and
in step S23, a recommendation keyword associated with the book recommendation features of the topic to be replied is extracted from the target topic content, and the book recommendation information is generated based on the recommendation keyword.

In an embodiment of the present disclosure, a book recommendation topic matched with the target recommended book may be determined from the posted book recommendation topic of the online reading application and marked as a first recommendation topic. The specific determining process is described as follows.

A book attribute feature of the target recommended book, such as a book title, a book author and a book character, is obtained. Then, the topic content of the posted book recommendation topics is matched with the book attribute feature of the target recommended book. If it is matched that a posted book recommendation topic contains topic content matched with the book attribute feature of the target recommended book (for example, containing topic content being same as the book attribute feature), the posted book recommendation topic is determined as the first recommendation topic.

After the first recommendation topic is determined, topic content of the first recommendation topic may be obtained. For example, topic recommendation content and topic reply content of the first recommendation topic may be obtained. Wherein, the topic recommendation content may be understood as a topic original of the first recommendation topic, and the topic reply content may be understood as reply information of other network users for the first recommendation topic.

Next, the target topic content associated with the target recommended book may be determined based on the topic content of the first recommendation topic. For example, the topic original of the first recommendation topic may be determined as the target topic content associated with the target recommended book. For another example, the topic reply content of the first recommendation topic may be determined as the target topic content associated with the target recommended book. Then, the book recommendation information of the target recommended book may be determined based on the target topic content.

In an optional embodiment, the target topic content may be directly determined as the book recommendation information of the target recommended book.

In another optional embodiment, a recommendation keyword associated with the book recommendation features of the topic to be replied may be extracted from the target topic content. Then, the book recommendation information may be generated based on the recommendation keyword.

In a specific implementation, word segmentation may be performed on the target topic content to obtain at least one initial token. After that, a correlation relationship between each initial token and the book recommendation features may be calculated. Then, an initial token with a correlation relationship satisfying a requirement is determined as a recommendation keyword, so as to obtain the book recommendation information of the target recommended book.

Here, for the target recommended book determined by the above-described second determining method, the first recommendation topic matched with the target recommended book may be determined among the posted book recommendation topics of the online reading application, and the book recommendation information of the target recommended book may also be determined by the method described above.

In the above-described embodiment, by way of the above-described processing method, the topic reply information may be automatically generated for the topic to be replied, thereby automatically replying to the topic to be replied, and enabling a faster access to a recommended book by the user.

In an optional embodiment, the method provided by an embodiment of the present disclosure further comprises the following steps:
in step S104, at least one preset reply template is obtained, and a target reply template matched with the topic to be replied is determined among the at least one preset reply template; and
in step S105, the step of generating the topic reply information of the topic to be replied based on the target recommended book and the book recommendation information comprises the following steps:
in step S1051, the topic reply information of the topic to be replied is generated based on the target reply template, the target recommended book and the book recommendation information.

In an embodiment of the present disclosure, first of all, a target account for replying to the topic to be replied may be determined. Then, a preset reply template matched with the target account may be determined among at least one preset reply template, wherein the preset reply templates corresponding to different target accounts may contain different template contents.

In an optional embodiment, the matched preset reply template may be determined as a target reply template.

In another optional embodiment, a book attribute feature of the topic to be replied may also be obtained, and then the preset reply template matched with the book attribute feature of the topic to be replied is determined among the matched preset reply templates as a target reply template. For example, if the book attribute feature is: young female, then the preset reply template matched with young female may be determined among the matched preset reply templates as a target reply template.

After the target reply template is determined, the topic reply information of the topic to be replied may be generated by combining the target reply template, the target recommended book and the book recommendation information. The process of generating the topic reply information will be determined below in conjunction with the following generating methods.

### First Generating Method

In this generating method, the target reply template does not contain a filling position.

At this time, the target reply template, the target recommended book and the book recommendation information may be arranged and combined in a preset sequence. Then, the combined information may be determined as the topic reply information.

For example, the topic reply information may be information in the following form:
Target reply template: are you faced with a book famine? Please accept the high-quality recommended collection from beautiful young girl right now;
Target recommended books: XXX and YYY;
Book recommendation information: the book recommendation information of XXX and the book recommendation information of YYY.

### Second Generating Method

In the second generating method, the target reply template contains a plurality of filling positions.

On such basis, the above-described step of generating the topic reply information of the topic to be replied based on the target reply template, the target recommended book and the book recommendation information specifically comprises the following steps:
First of all, filling content of each of the filling positions is determined based on the topic to be replied, and a first reply information is generated based on the filling content;
Then, a second reply information is generated based on the target recommended book and the book recommendation information;
Next, the first reply information and the second reply information are combined to obtain the topic reply information.

In an embodiment of the present disclosure, if the target reply template contains a filling position, filling content of each filling position may be determined based on the topic to be replied, wherein the filling content corresponding to the filling position is content associated with the topic to be replied. For example, the target reply template may be a template in the following form:

Hello, Miss “XXX”, a book “MMM” related to “YYY character” of your interest has been found out for you. Please accept the high-quality recommended collection from “NNN”.

Here, “XXX” is configured to indicate a user nickname of a posting user, “YYY Character” is configured to indicate a character in the book recommendation label, “MMM” may be a book title of the target recommended book, and “NNN” may be an account nickname of the target account.

After the filling content of each filling position is determined, the filling content may be added to the corresponding filling position, so as to obtain the first reply information. For example, the first reply information may be:

Hello, Miss XXX, a book M related to Lin Qiye of your interest has been found out for you. Please accept the high-quality recommended collection from XiaoJia.

Next, the second reply information may also be generated based on the target recommended book and the book recommendation information. For example, the target recommended book and the book recommendation information may be combined to obtain the second reply information. Then, the first reply information and the second reply information may be combined to obtain the topic reply information. For example, the first reply information and the second reply information may be combined as described in the above first generating method to obtain the topic reply information.

In the above-described embodiment, by determining the target reply template matched with the topic to be replied, and generating the topic reply information based on the target reply template, the topic reply information may be customized for the user, thereby further improving the user experience.

### Second Embodiment

Referring to FIG. 4, it is a flowchart of another reply method applied to a client provided by an embodiment of the present disclosure, which comprises steps S401˜S405, wherein:

In step S401, a topic browsing request is detected and a target recommendation topic corresponding to the topic browsing request is determined.

In step S403, topic content of the target recommendation topic is obtained; wherein the topic content comprises topic recommendation content and topic reply content, and the topic reply content is the topic reply information generated for the target recommendation topic by the reply method according to any of the first embodiments.

In step S405, the topic reply content is displayed in a topic reply area of a topic display page.

Here, after it may be detected that the user opens the client corresponding to an online reading application, if the user's topic browsing request for a topic is detected, a target recommendation topic corresponding to the topic browsing request may be determined.

After the target recommendation topic is determined, the client may send an obtaining request of topic content of the target recommendation topic to the server. After obtaining the obtaining request, the server may search the topic content of the target recommendation topic in the database.

Here, the topic content of the target recommendation topic may comprise a topic original (i.e., the topic recommended content) and topic reply content, wherein the topic reply content may at least comprise the topic reply information generated for the target recommendation topic by the method described in the first embodiment described above. Wherein, the topic reply information may be a post reply for the target recommendation topic by the target account.

In the above-described embodiment, by generating the topic reply information based on the target recommended book and the book recommendation information, the topic reply information may be automatically generated for the topic to be replied, thereby automatically replying to the topic to be replied, and enabling a faster access to a recommended book by the user. By determining a target recommended book and the book recommendation information matched with the book recommendation features of the topic to be replied, it is possible to obtain the target recommended book that conforms more to a book recommendation intent of the user, thereby obtaining the topic reply information more matched with the topic to be replied, and further improving the reading experience of the user.

In an optional embodiment, the above-described step S405 of displaying the topic reply content in the topic display page specifically comprises the following steps:
in step S4051, a target recommended book in the topic reply content is determined, and a book display identifier of the target recommended book is determined;
in step S4052, text content in the topic reply content is determined and critical text information of the text content is extracted; and
in step S4053, the book display identifier is displayed in multimedia display area of the topic reply area, and the critical text information is displayed in text display area of the topic reply area.

In an embodiment of the present disclosure, after the topic content of the target recommendation topic is obtained, a target recommended book may be determined in the topic reply content of the topic content, and a book display identifier of the target recommended book may be determined, wherein the book display identifier may be a thumbnail of a promotional poster of the target recommended book, a thumbnail of a book cover of the target recommended book, or other identifiers of the target recommended book, for example, identifiers such as a jump link of multimedia delivery information of the target recommended book, or a jump link of a book reading page of the target recommended book. Then, it is also possible to determine text content in the topic reply content and extract critical text information of the text content.

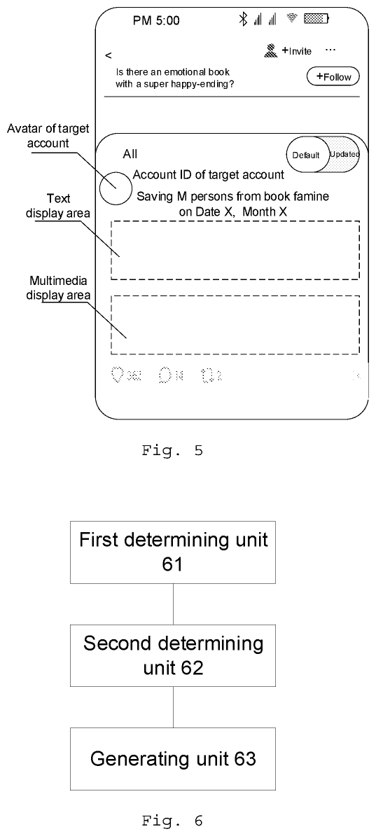

Next, as shown in FIG. 5, the above-described book display identifier may be displayed in the multimedia display area of the topic reply area in the topic browsing page, and the critical text information may be displayed in the text display area of the topic reply area.

Here, if the book recommendation information comprises multimedia delivery information of the target recommended book, the multimedia delivery information may also be displayed in the multimedia display area. For example, information such as a video playing window and an audio playing window may be displayed.

In an optional embodiment, the method provided by the embodiment of the present disclosure further comprises the following steps:

Switch to a recommendation details page displaying the target recommended book in response to a triggering operation on the book display identifier; wherein the recommendation details page comprises a book reading page of the target recommended book, and/or a delivery page of the multimedia delivery information of the target recommended book on a target delivery platform.

In an embodiment of the present disclosure, after the user's trigger operation on the book display identifier is detected, it is possible to jump to a recommendation details page of the target recommended book, for example, a book reading page of the target recommended book, and/or a delivery page of the multimedia delivery information of the target recommended book on a target delivery platform.

In the above-described embodiment, by setting a triggerable book display identifier for the user, it is possible to realize communication with other functional modules of the target recommended book, for example, communication with a reading module and communication with a delivery platform, so that the user can quickly obtain other related information of the target recommended book, for example, a book reading page and a delivery page by way of said communication.

It may be understood by those skilled in the art that, in the above-described method of specific embodiments, a draft sequence of steps does not mean a strict performing sequence to constitute any limitation on the implementation process, and the specific performing sequence of the steps should be determined according to their functions and possible internal logic.

### Third Embodiment

Based on the same inventive concept, the embodiments of the present disclosure also provide a reply device corresponding to the reply method. Since the principle of solving the problem by the device in the embodiments of the present disclosure is similar to the above-described reply method in the embodiments of the present disclosure, the implementation of the device may refer to the implementation of the method, which will not be described in detail here for repeated parts.

Referring to FIG. 6, it is a schematic view of a reply device provided by an embodiment of the present disclosure. The device comprises: a first determining unit 61, a second determining unit 62, and a generating unit 63; wherein,
the first determining unit is configured to determine a topic to be replied among posted book recommendation topics; wherein the topic to be replied corresponds to at least one book recommendation feature;
the second determining unit is configured to determine a target recommended book matched with the topic to be replied, and determine book recommendation information of the target recommended book; wherein the book recommendation information contains information matched with at least some of book recommendation features; and
the generating unit is configured to generate topic reply information of the topic to be replied based on the target recommended book and the book recommendation information.

In a possible implementation, the second determining unit is further configured to: determine a plurality of book screening features based on the topic content of the topic to be replied; determine a book recommendation collection corresponding to each of the book screening features among a plurality of candidate recommended books so as to obtain a plurality of book recommendation collections; determine a book that satisfies a book recommendation requirement among the plurality of book recommendation collections as the target recommended book.

In a possible implementation, the book screening features comprise at least one of the following: gender information of a posting user of the topic to be replied, a book recommendation label of the topic to be replied, or operation information of a related book on which a target operation is performed by the posting user, wherein the book recommendation label is configured to indicate classification information of a book associated with the topic to be replied, and the target operation comprises at least one of the following: a reading operation or a commenting operation.

In a possible implementation, the second determining unit is further configured to: determine a first recommendation topic matched with the target recommended book among posted book recommendation topics; determine target topic content associated with the target recommended book in topic content of the first recommendation topic. The target topic content comprises at least one of the following: topic reply content or topic recommendation content; extract a recommendation keyword associated with the book recommendation features of the topic to be replied from the target topic content, and generate the book recommendation information based on the recommendation keyword.

In a possible implementation, the second determining unit is further configured to extract book delivery information from the topic content of the topic to be replied, wherein the book delivery information is configured to indicate a target delivery platform of multimedia information of a book associated with the topic to be replied; and determine the target recommended book among books delivered by the target delivery platform based on the book delivery information.

In a possible implementation, the second determining unit is further configured to: obtain target delivery information of the target recommended book on the target delivery platform, wherein the target delivery information comprises multimedia delivery information of the target recommended book and/or comment information of the multimedia delivery information; extract critical delivery information matched with the book recommendation features of the topic to be replied from the target delivery information, and determine the book recommendation information of the target recommended book based on the critical delivery information.

In a possible implementation, the device is further configured to: obtain at least one preset reply template and determine a target reply template matched with the topic to be replied in the at least one preset reply template. The generating unit is further configured to: generate the topic reply information of the topic to be replied based on the target reply template, the target recommended book and the book recommendation information.

In a possible implementation, the generating unit is further configured to: in the case where the target reply template contains a plurality of filling positions, determine filling content of each of the filling positions based on the topic to be replied, and generate a first reply information based on the filling content; generate a second reply information based on the target recommended book and the book recommendation information; and combine the first reply information and the second reply information to obtain the topic reply information.

### Fourth Embodiment

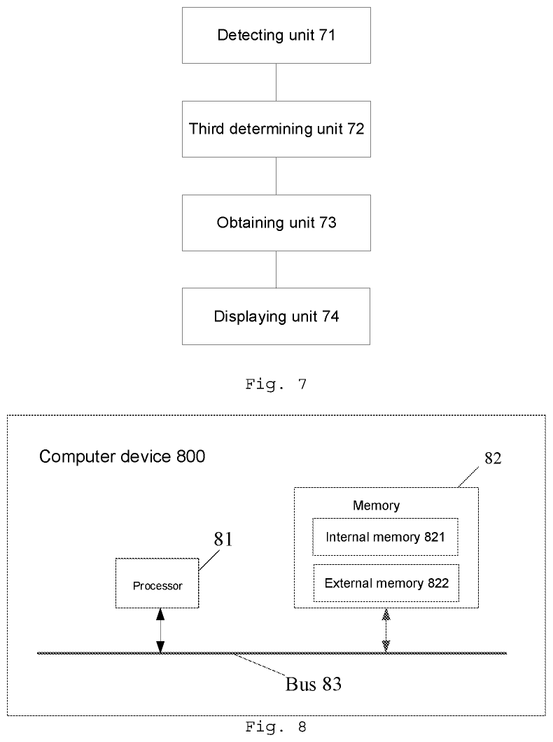

Referring to FIG. 7, it is a schematic view of a reply device provided by an embodiment of the present disclosure. The device comprises: a detecting unit 71, a third determining unit 72, an obtaining unit 73, and a displaying unit 74. Wherein,
the detecting unit 71 is configured to detect a topic browsing request;
the third determining unit 72 is configured to determine a target recommendation topic corresponding to the topic browsing request;
the obtaining unit 73 is configured to obtain topic content of the target recommendation topic; wherein the topic content comprises topic recommendation content and topic reply content, and the topic reply content is the topic reply information generated for the target recommendation topic by the reply method according to any of the first embodiment described above; and
the displaying unit 74 is configured to display the topic reply content in a topic reply area of a topic display page.

In a possible implementation, the displaying unit is configured to: determine a target recommended book in the topic reply content and determine a book display identifier of the target recommended book; determine text content in the topic reply content and extract critical text information of the text content; display the book display identifier in a multimedia display area of the topic reply area, and display the critical text information in a text display area of the topic reply area.

In a possible implementation, the device is further configured to: switch to a recommendation details page displaying the target recommended book in response to a triggering operation on the book display identifier; wherein the recommendation details page comprises a book reading page of the target recommended book and/or, a delivery page of multimedia delivery information of the target recommended book on a target delivery platform.

For the description of the processing flow of various units in the device and the interaction flow between various units, reference may be made to the relevant description in the above-described method embodiments, which will not be described in detail here.

### Fifth Embodiment

Corresponding to the reply method in FIG. 1, the embodiments of the present disclosure also provide a computer device 800, as shown in FIG. 8, which is a structural schematic view of the computer device 800 provided by an embodiment of the present disclosure, comprising: a processor 81, a memory 82, and a bus 83. The memory 82 is configured to store execution instructions, and comprises an internal memory 821 and an external memory 822. The internal memory 821 here is also referred to as internal storage, which is configured to temporarily store operation data in the processor 81 and data exchanged with the external memory 822 such as a hard disk. The processor 81 exchanges the data with the external memory 822 through the internal memory 821, and during the operation of the computer device 800, the processor 81 communicates with the memory 82 via the bus 83, so that the processor 81 executes the instructions of:
determining a topic to be replied among posted book recommendation topics; wherein the topic to be replied corresponds to at least one book recommendation feature;
determining a target recommended book matched with the topic to be replied, and determining book recommendation information of the target recommended book; wherein the book recommendation information contains information matched with at least some of book recommendation features; and
generating topic reply information of the topic to be replied based on the target recommended book and the book recommendation information.

Besides, the processor 81 also executes the instructions of:
detecting a topic browsing request, and determining a target recommendation topic corresponding to the topic browsing request;
obtaining topic content of the target recommendation topic; wherein the topic content comprises topic recommendation content and topic reply content, and the topic reply content is the topic reply information generated for the target recommendation topic by the reply method according to any of the first embodiment described above; and
displaying the topic reply content in a topic reply area of a topic display page.

The embodiments of the present disclosure also provide a non-transitory computer-readable storage medium having a computer program stored thereon that, when executed by a processor, performs the steps of the reply method according to the above-described method embodiments. Wherein, the storage medium may be a volatile or nonvolatile computer-readable storage medium.

The embodiments of the present disclosure also provide a computer program product which carries a program code, wherein the program code comprises instructions that may be used to perform the steps of the reply method according to the above-described method embodiment. Specifically, reference may be made to the above-described method embodiments, which will not be described in detail here.

Wherein, the above-described computer program product may be realized by hardware, software or a combination thereof. In an optional embodiment, the computer program product is embodied as a computer storage medium, and in another optional embodiment, the computer program product is embodied as a software product, such as a Software Development Kit (SDK) and the like.

It may be clearly understood by those skilled in the art that for convenient and concise description, for the specific operation process of the system and device described above, reference may be made to the corresponding process in the aforementioned method embodiments, which will not be described in detail here. In several embodiments provided by this disclosure, it should be understood that the disclosed systems, devices and methods may be realized in other methods. The device embodiments described above are only illustrative. For example, the division of units is only a logical function division, and there may be another division method in actual implementation. For example, a plurality of units or components may be combined or integrated into another system, or some features may be neglected or not performed. On the other hand, the mutual coupling or direct coupling or communication connection shown or discussed may be indirect coupling or communication connection through some communication interfaces, devices or units, which may be electrical, mechanical or in other forms.

The units described as separate components may or may not be physically separated, and the components displayed as units may or may not be physical units, that is, they may be located in one place or distributed on a plurality of network units. Some or all of the units may be selected according to actual needs to achieve the purpose of the solution of this embodiment.

In addition, each functional unit in each embodiment of the present disclosure may be integrated into one processing unit, or each unit may exist physically alone, or two or more units may be integrated into one unit.

The functions, if implemented in the form of software functional units and sold or used as independent products, may be stored in a nonvolatile computer-readable storage medium that may be executed by a processor. Based on this understanding, the technical solution of the present disclosure in essence or a part thereof that makes contribution over the prior art or a part of this technical solution may be embodied in the form of a software product stored in a storage medium and comprise several instructions to cause a computer device (which may be a personal computer, a server, a network device, or the like) to perform all or some of the steps of the method according to various embodiments of the present disclosure. The aforementioned storage medium comprises: various media that may store program codes, such as a USB flash disk, a mobile hard disk, a Read-Only Memory (ROM), a Random Access Memory (RAM), a magnetic disk or an optical disk.

Finally, it is to be noted that: the above-described embodiments are only specific embodiments of the present disclosure, which are intended to explain the technical solution of the present disclosure, rather than restricting the same. The protection scope of the present disclosure is not limited thereto. Although this disclosure has been described in detail with reference to the aforementioned embodiments, it should be understood by those of ordinary skill in the art that: those skilled in the art whoever are familiar with the technical field may still modify or easily conceive of changes to the technical solution recited in the aforementioned embodiments, or perform equivalent replacement of some technical features thereof, within the technical scope of the present disclosure. However, these modifications, changes or replacements do not make the essence of the corresponding technical solution depart from the spirit and scope of the technical solution of the embodiment of this disclosure, and should be included in the protection scope of this disclosure. Therefore, the protection scope of this disclosure should be determined according to the protection scope of the claims.

What is claimed is:

1. A reply method applied to a server, comprising:
determining a topic to be replied among posted book recommendation topics; wherein the topic to be replied corresponds to at least one book recommendation feature;
determining a target recommended book matched with the topic to be replied, and determining book recommendation information of the target recommended book; wherein the book recommendation information contains information matched with at least some of book recommendation features; and
generating topic reply information of the topic to be replied based on the target recommended book and the book recommendation information.

2. The method according to claim 1, wherein the determining the target recommended book matched with the topic to be replied comprises:
determining a plurality of book screening features based on topic content of the topic to be replied;
determining a book recommendation collection corresponding to each of the book screening features among a plurality of candidate recommended books so as to obtain a plurality of book recommendation collections; and
determining a book satisfying a book recommendation requirement among the plurality of book recommendation collections as the target recommended book.

3. The method according to claim 2, wherein the book screening features comprise at least one of the following: gender information of a posting user of the topic to be replied, a book recommendation label of the topic to be replied, or operation information of a related book on which a target operation is performed by the posting user, wherein the book recommendation label is configured to indicate classification information of a book associated with the topic to be replied, and the target operation comprises at least one of the following: a reading operation or a commenting operation.

4. The method according to claim 1, wherein the determining the book recommendation information of the target recommended book comprises:
determining a first recommendation topic matched with the target recommended book among posted book recommendation topics;
determining target topic content associated with the target recommended book in topic content of the first recommendation topic;
wherein the target topic content comprises at least one of the following: topic reply content or topic recommendation content; and
extracting a recommendation keyword associated with the book recommendation features of the topic to be replied from the target topic content, and generating the book recommendation information based on the recommendation keyword.

5. The method according to claim 1, wherein the determining the target recommended book matched with the topic to be replied comprises:
extracting book delivery information from topic content of the topic to be replied; wherein the book delivery information is configured to indicate a target delivery platform of multimedia information of a book associated with the topic to be replied; and
determining the target recommended book among books delivered by the target delivery platform based on the book delivery information.

6. The method according to claim 5, wherein the determining the book recommendation information of the target recommended book comprises:
obtaining target delivery information of the target recommended book on the target delivery platform, wherein the target delivery information comprises multimedia delivery information of the target recommended book and/or comment information of the multimedia delivery information; and
extracting critical delivery information matched with the book recommendation features of the topic to be replied from the target delivery information, and determining the book recommendation information of the target recommended book based on the critical delivery information.

7. The method according to claim 1, wherein the method further comprises:
obtaining at least one preset reply template, and determining a target reply template matched with the topic to be replied in the at least one preset reply template; and
the generating the topic reply information of the topic to be replied based on the target recommended book and the book recommendation information comprises: generating the topic reply information of the topic to be replied based on the target reply template, the target recommended book and the book recommendation information.

8. The method according to claim 7, wherein the target reply template contains a plurality of filling positions; the generating the topic reply information of the topic to be replied based on the target reply template, the target recommended book and the book recommendation information comprises:
determining filling content of each of the filling positions based on the topic to be replied, and generating a first reply information based on the filling content;
generating a second reply information based on the target recommended book and the book recommendation information; and
combining the first reply information and the second reply information to obtain the topic reply information.

9. A reply method applied to a client, comprising:
detecting a topic browsing request and determining a target recommendation topic corresponding to the topic browsing request;
obtaining topic content of the target recommendation topic; wherein the topic content comprises topic recommendation content and topic reply content, and the topic reply content is the topic reply information generated for the target recommendation topic by the reply method according to claim 1; and
displaying the topic reply content in a topic reply area of a topic display page.

10. The method according to claim 9, wherein the displaying the topic reply content in the topic display page comprises:
determining a target recommended book in the topic reply content, and determining a book display identifier of the target recommended book;
determining text content in the topic reply content, and extracting critical text information of the text content; and
displaying the book display identifier in a multimedia display area of the topic reply area, and displaying the critical text information in a text display area of the topic reply area.

11. The method according to claim 10, wherein the method further comprises:
switching to a recommendation details page displaying the target recommended book in response to a triggering operation on the book display identifier; wherein the recommendation details page comprises: a book reading page of the target recommended book and/or, a delivery page of multimedia delivery information of the target recommended book on a target delivery platform.

12. A computer device, comprising a processor, a memory and a bus, wherein the memory stores machine-readable instructions executable by the processor, so that the processor communicates with the memory via the bus during the operation of the computer device; and the machine-readable instructions, when executed by the processor, perform the steps of:
determining a topic to be replied among posted book recommendation topics; wherein the topic to be replied corresponds to at least one book recommendation feature;
determining a target recommended book matched with the topic to be replied, and determining book recommendation information of the target recommended book; wherein the book recommendation information contains information matched with at least some of book recommendation features; and
generating topic reply information of the topic to be replied based on the target recommended book and the book recommendation information.

13. The computer device according to claim 12, wherein the step of determining the target recommended book matched with the topic to be replied comprises:
determining a plurality of book screening features based on topic content of the topic to be replied;
determining a book recommendation collection corresponding to each of the book screening features among a plurality of candidate recommended books so as to obtain a plurality of book recommendation collections; and
determining a book satisfying a book recommendation requirement among the plurality of book recommendation collections as the target recommended book.

14. The computer device according to claim 13, wherein the book screening features comprise at least one of the following: gender information of a posting user of the topic to be replied, a book recommendation label of the topic to be replied, or operation information of a related book on which a target operation is performed by the posting user, wherein the book recommendation label is configured to indicate classification information of a book associated with the topic to be replied, and the target operation comprises at least one of the following: a reading operation or a commenting operation.

15. The computer device according to claim 12, wherein the step of determining the book recommendation information of the target recommended book comprises:
determining a first recommendation topic matched with the target recommended book among posted book recommendation topics;
determining target topic content associated with the target recommended book in topic content of the first recommendation topic; wherein the target topic content comprises at least one of the following: topic reply content or topic recommendation content; and
extracting a recommendation keyword associated with the book recommendation features of the topic to be replied from the target topic content, and generating the book recommendation information based on the recommendation keyword.

16. The computer device according to claim 12, wherein the step of determining the target recommended book matched with the topic to be replied comprises:
extracting book delivery information from topic content of the topic to be replied; wherein the book delivery information is configured to indicate a target delivery platform of multimedia information of a book associated with the topic to be replied; and
determining the target recommended book among books delivered by the target delivery platform based on the book delivery information.

17. The computer device according to claim 16, wherein the step of determining the book recommendation information of the target recommended book comprises:
obtaining target delivery information of the target recommended book on the target delivery platform, wherein the target delivery information comprises multimedia delivery information of the target recommended book and/or comment information of the multimedia delivery information; and
extracting critical delivery information matched with the book recommendation features of the topic to be replied from the target delivery information, and determining the book recommendation information of the target recommended book based on the critical delivery information.

18. A non-transitory computer-readable storage medium having a computer program stored thereon that, when executed by a processor, performs the steps of the reply method according to claim 1.

19. A computer device, comprising a processor, a memory and a bus, wherein the memory stores machine-readable instructions executable by the processor, so that the processor communicates with the memory via the bus during the operation of the computer device; and the machine-readable instructions, when executed by the processor, perform the steps of the reply method according to claim 9.

20. A non-transitory computer-readable storage medium having a computer program stored thereon that, when executed by a processor, performs the steps of the reply method according to claim 9.
